(19) United States
(12) Patent Application Publication
(10) Pub. No.: US 2001/0030862 A1
(43) Pub. Date: Oct. 18, 2001

(54) Cordless decorative light assembly

(76) Inventor: Noel C. Simms, Arlington, VA (US)

Correspondence Address: Miles & Stockbridge, P.C., Suite 500, 1751 Pinnacle Drive, McLean, VA, 22102-3833, US

(21) Appl. No.: 09/729,928

(22) Filed: Dec. 6, 2000

Related U.S. Application Data
(60) Provisional application No. 60/169,292, filed on Dec. 7, 1999.

(51) Int. Cl. F21L 4/00; F21W 121/04

(52) U.S. Cl. 362/123; 362/191; 362/806; 362/802

(57) ABSTRACT

An improved decorative light bulb assembly for Christmas tree lights, Christmas decorations, ornamental lights, decorative lights and the like comprising a plurality of electric light bulbs, each housed in a fixture, the improvement wherein each of the fixtures contains its own power source for actuating the bulb housed therein, giving rise to a cordless assembly of decorative lights which may be actuated remotely according to any desired pattern.

### BACKGROUND OF THE INVENTION

1. Field of the Invention

The present invention relates to a cordless decorative light bulb assembly, more particularly, to a light bulb assembly for Christmas tree decorations, ornamental lights, decorative lights and the like. Description of the Prior Art:

Prior art decorative light bulb assemblies typically comprise a plurality of electric light bulbs, each housed in an electric fixture which supplies electric current to each bulb. Typically, each such fixture is located on a common electric cord which supplies the necessary electric current to each fixture. These so-called “light strings” suffer from the disadvantage that allowance must be made for the common electric cord when positioning or “stringing” the lights in the desired decorative location. The very presence of the cord not only physically hinders the placement of the lights, it also dictates to a large extent the precise location of each light in the overall decorative scheme. Thus, it is usually necessary to make many adjustments in the position of the string of lights in order to achieve a satisfactory result. Moreover, its presence visually detracts from the decorative effect of the light assembly.

Taking the example of “stringing” lights on a Christmas tree, not only is the cord an annoying and frustrating presence which interferes with placing the lights on the tree, it also dictates where the light can and cannot be placed. For example, it is often desirable to place some of the lights in the interior of the tree foliage, i.e., near the trunk. However, the presence of the cord renders such placement problematic. Thus, the cord may physically prevent the location of a particular light bulb at a certain interior location because the length of cord between the fixed light fixtures is not of an appropriate length. Moreover, the fact of a fixed cord length between fixtures prevents an appropriate distribution of lights in a three-dimensional space; i.e., the placement of a light near the trunk of the tree with the preceding and the following light placements to be made at the exterior of the tree must be made mindful of the fixed length of cord therebetween rather than any aesthetic or spatial considerations.

It is an object of the present invention, therefor, to provide an assembly of light bulbs, which is “cordless” but yet are mutually actuatable to provide a decorative light effect.

### SUMMARY OF THE INVENTION

The foregoing and other objects are realized by the present invention, one embodiment of which relates to a cordless decorative light assembly comprising an assemblage of electrically actuated light sources, each housed in a fixture adapted to supply electric power to the light sources, wherein each of the fixtures contains (1) means for delivering electric power to the light source, (2) switch means for actuating and stopping the delivery of electric power in response to a remote controlled command, and (3) means for receiving and delivering the remote controlled command to the switch means.

A second embodiment of the invention comprises an assemblage of fixtures adapted to supply electric power to light sources which they are adapted to house, wherein each of the fixtures contains (1) means for delivering electric power to the light source, (2) switch means for actuating and stopping the delivery of electric power to the light source in response to a remote controlled command, and (3) means for receiving and delivering the remote controlled command to the switch means.

Still another embodiment of the invention concerns an assemblage of fixtures adapted to supply electric power to light sources which they are adapted to house, wherein each of the fixtures contains (1) means for delivering electric power to the light source, (2) switch means for actuating and stopping the delivery of electric power to the light source in response to a remote controlled command, and (3) means for receiving and delivering the remote controlled command to the switch means in combination with a means for delivering the remote control command.

Further embodiments of the invention relate to the above-described inventive concepts in combination with means for attaching the fixtures at any of a plurality of locations on one or more recipient surfaces.

### BRIEF DESCRIPTION OF THE DRAWINGS

FIG. 1 is a side elevational view of an electric light bulb and fixture in an assembly of the invention.

FIG. 2 is a sectional view of FIG. 1 along the line 2-2′.

FIG. 3 is a side elevational view of a Christmas tree bearing the light assembly of the invention.

FIG. 4 is a side elevational view of a Christmas tree branch bearing an electric light bulb of the assembly of the invention.

FIG. 5 is an elevational view of a hand-held device for remote control of the assembly of the invention.

### DETAILED DESCRIPTION OF THE INVENTION

The crux of the invention resides in the fact that that each of the fixtures contains its own power source for actuating the bulb housed therein, the power sources being mutually independent and physically unconnected. Each fixture further contains means for receiving a remote control command to actuate the bulbs in the assembly according to a predetermined pattern.

The invention, thus, in its simplest embodiment, provides a unique “cordless” Christmas tree light assembly.

The invention is described hereinbelow with particular reference to the use of the light assembly as a Christmas tree decoration; however, it will be understood by those skilled in the art that the assembly described herein can be modified or adapted without the exercise of inventive faculties to comprise a decorative assembly for any platform or surfaces requiring the distribution thereon of mutually actuatable electric lights for a decorative effect.

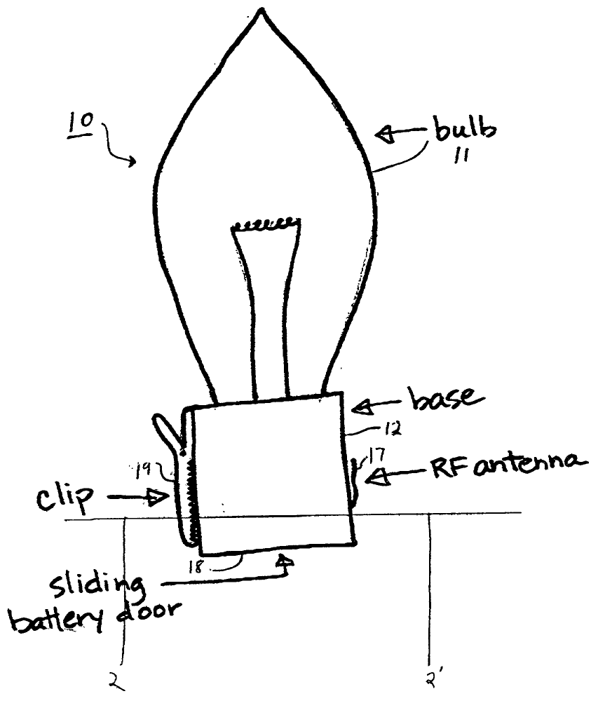

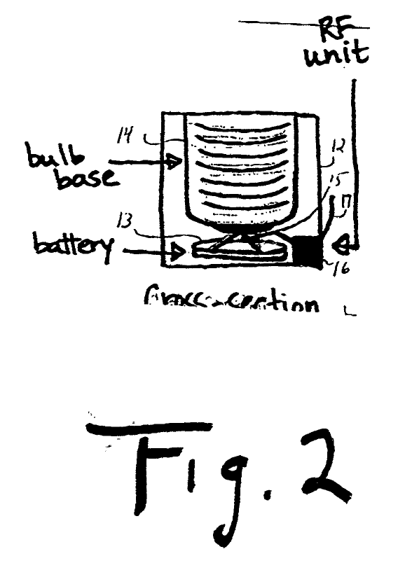

As shown in FIGS. 1 and 2, each decorative light 10 comprising the assembly comprises a typical electric light bulb or light emitting diode (LED) 11 [Typical such LEDs are described in U.S. Pat. No. 4,675,575, the entire contents and disclosure of which is incorporated herein by reference], which may be of any suitable color or, of course, plain “white,” housed in fixture 12. Housed within fixture 12 is an electric power source 13.

The electric bulb base 14, when fully inserted in fixture 12, forms an actuatable electric connection 15 with electric power source 13. Also housed in fixture 12 is electric actuation or switch means 16 which, upon receiving a command signal through receiving means 17, allows flow of an electric current through connection 15 to actuate bulb 11. A removable closure may be located at 18 for accessing the power source 13 and actuation means 16. A means 19 such as, e.g., an alligator clip, for attaching the decorative light to a substrate may be located on the fixture 12.

Any suitable electric light bulb or LED 11 and fixture 12 may be employed in the assembly of the invention. Typical suitable decorative lights include ornamental Christmas lights such as Christmas tree lights and the like. The only requirement that the fixture must satisfy is that it must be of sufficient size to accommodate the power source 13 as well as the light 11. The particular size and shape of the fixture in any specific application will depend upon the size and shape of the power source employed. It will, of course, be desirable to construct the fixture such that it is as small and light as possible in order to facilitate its placement on the surface to be decorated while interfering as little as possible with the visual effect intended.

The electric power source 13 may comprise any suitable such source of appropriate size for inclusion in a housing for a typical decorative light Exemplary of such power sources are batteries, fuel cells and the like. Typical of such power sources are the rechargeable lithium batteries described in U.S. Pat. No. 6,007,945, or the batteries and cells described in U.S. Pat. No. 5,839,814 the entire contents and disclosures of both of which are incorporated herein by reference. It will be understood, however, by those skilled in the art that the size and shape of the power source will be determined in each application by the power requirements of the electric light employed and the length of time desirable between replacements or recharging thereof. Where it is desired to employ the assembly in applications requiring relatively long periods of “on” time it will be necessary to utilize larger power sources than in those instances where the lights are lit for only short periods of time.

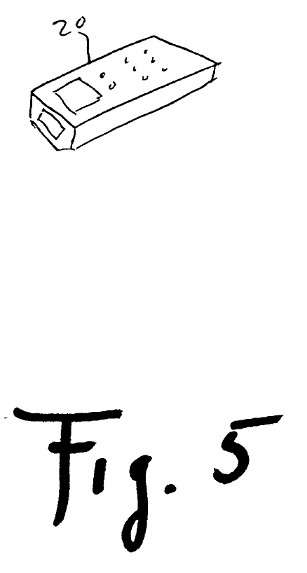

Actuation or switch means 16 may comprise any suitable such device which actuates the electrical connection 15 upon receiving a command signal from a remote command device 20 (depicted in FIG. 5) through receiving means 17. Exemplary of such remote command devices are radio frequency (RF) devices, infrared devices, acoustic signal devices (such as those described in U.S. Pat. Nos. 5,615,271 and 5,493,618, the entire contents and disclosure of which are incorporated herein by reference) and the like.

The remote command receiving means 17 may comprise an RF antenna, IR sensing device, or acoustic receiving device, respectively. The signal to actuate the electrical connection may be delivered to the actuation means 16 through receiving means 17 by, e.g., a hand-held remote control unit 20.

Typical of radio frequency sensing systems is that shown in U.S. Pat. No. 5,383,044, the entire contents and disclosure of which is incorporated herein by reference.

Suitable infrared type device included any one of those described in U.S. Pat. No. 4,809,359, the entire contents and disclosure of which is also incorporated herein by reference.

A preferred embodiment contemplates the utilization of a light emitting diode powered by a miniaturized fuel cell.

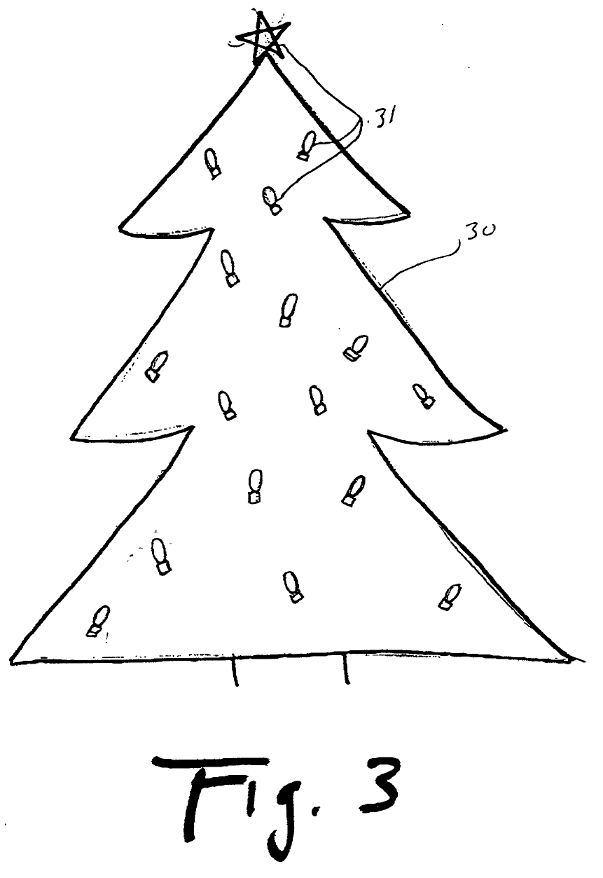

FIG. 3 depicts a side elevational view of a typical Christmas tree 30 to which are affixed the decorative lights 31 of the assembly of the invention.

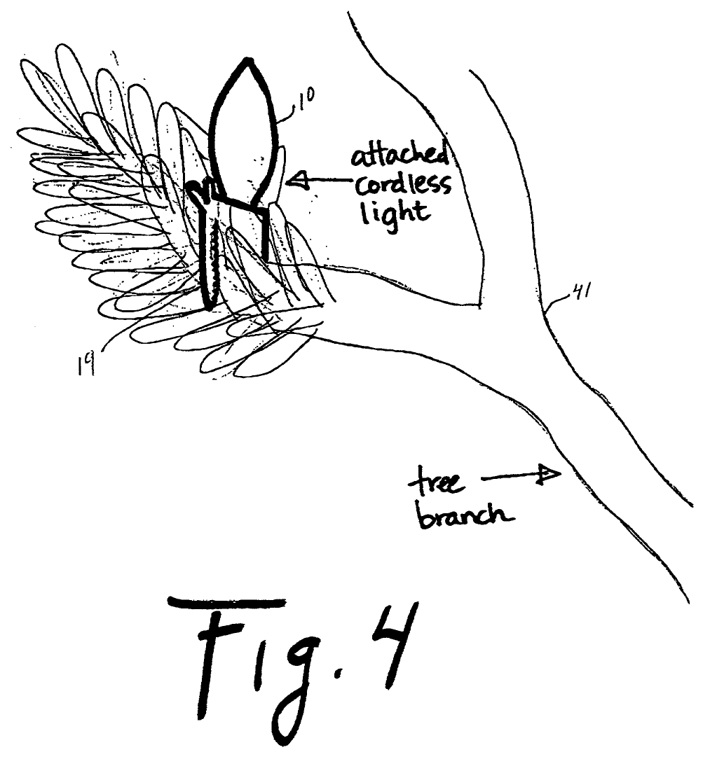

FIG. 4 depicts a representation of a branch 41 of a typical Christmas tree to which is affixed by means of clip 19 a decorative light 10 of the assembly of the invention.

FIG. 5 represents an elevational view of a typical hand-held remote control unit 20 for actuating the lights of the assembly of the invention.

Although the assembly of the invention is illustrated herein as being actuatable by electromagnetic energy such as infrared or radio frequency radiation, those skilled in the art will appreciate that the assembly of the invention may also be actuated by remotely transmitted acoustic energy such as sonic energy, as illustrated in the above-described U.S. Pat. Nos. 5,493,618 and 5,615,271.

1. A cordless decorative light assembly comprising an assemblage of electrically actuated light sources, each housed in a fixture adapted to supply electric power to said light sources, wherein each of said fixtures contains (1) means for delivering electric power to said light source, (2) switch means for actuating and stopping said delivery of electric power in response to a remote controlled command, and (3) means for receiving and delivering said remote controlled command to said switch means.

2. A cordless decorative light assembly according to claim 1 wherein said means for delivering said electric power is a battery.

3. A cordless decorative light assembly according to claim 2 wherein said battery is a rechargeable battery.

4. A cordless decorative light assembly according to claim 3 wherein said battery is a lithium battery.

5. A cordless decorative light assembly according to claim 1 wherein said means for delivering said electric power is a fuel cell.

6. A cordless decorative light assembly according to claim 1 wherein said light sources are electric bulbs.

7. A cordless decorative light assembly according to claim 1 wherein said light sources are light-emitting diodes.

8. A cordless decorative light assembly according to claim 1 wherein said remote controlled command is radio frequency signal.

9. A cordless decorative light assembly according to claim 1 wherein said remote controlled command is an infrared signal.

10. A cordless decorative light assembly according to claim 1 wherein said remote controlled command is an acoustical signal.

11. A cordless decorative light assembly according to claim 1 in combination with a means for delivering said remote control command.

12. The cordless decorative light assembly according to claim 11 wherein said remote control command is radio frequency signal.

13. The cordless decorative light assembly according to claim 11 wherein said remote controlled command is an infrared signal.

14. The cordless decorative light assembly according to claim 11 wherein said remote controlled command is an acoustical signal.

15. An assemblage of fixtures as described in claim 1.

16. An assemblage of fixtures as described in claim 2.

17. An assemblage of fixtures as described in claim 3.

18. An assemblage of fixtures as described in claim 4.

19. An assemblage of fixtures as described in claim 5.

20. An assemblage of fixtures as described in claim 8.

21. An assemblage of fixtures as described in claim 9.

22. An assemblage of fixtures as described in claim 10.

23. An assemblage of fixtures as described in claim 1 in combination with a means for delivering said remote control command.

24. An assemblage of fixtures as described in claim 23 wherein said remote control command is radio frequency signal.

25. An assemblage of fixtures as described in claim 23 wherein said remote controlled command is an infrared signal.

26. An assemblage of fixtures as described in claim 23 wherein said remote controlled command is an acoustical signal.

27. A cordless decorative light assembly according to claim 1 in combination with means for attaching said fixtures at any of a plurality of locations on one or more recipient surfaces.

28. An assemblage of fixtures as described in claim 1 in combination with means for attaching said fixtures at any of a plurality of locations on one or more recipient surfaces.

29. The combination of claim 11 in combination with means for attaching said fixtures at any of a plurality of locations on one or more recipient surfaces.
